(19) United States
(12) Patent Application Publication
(10) Pub. No.: US 2011/0169803 A1
(43) Pub. Date: Jul. 14, 2011

(54) LIQUID CRYSTAL DISPLAY DEVICE

(75) Inventors: Norifumi Kikuchi, Kanagawa (JP); Shinji Ogawa, Tokyo (JP); Yoriaki Yoshizawa, Tokyo (JP)

(73) Assignee: Sony Corporation, Tokyo (JP)

(21) Appl. No.: 12/971,973

(22) Filed: Dec. 17, 2010

(30) Foreign Application Priority Data
Jan. 13, 2010 (JP) 2010-005083

(51) Int. Cl. G09G 3/36; G06F 3/038

(52) U.S. Cl. 345/211; 345/94

(57) ABSTRACT

A liquid crystal display device includes: a light source section; a liquid crystal display panel including pixels and performing video display; and a drive section. The drive section performs the driving on the light source section for turning ON and OFF in synchronization with the driving of the pixels for the light-sequential writing such that, the liquid crystal display panel is selectively illuminated with the light from a lower emission region in the light source section when the pixels in an upper display region are under the driving for line-sequential writing, and such that, the liquid crystal display panel is selectively illuminated with the light from an upper emission region when the pixels in a lower display region are under the driving for line-sequential writing. A phase difference between emission periods in the upper and lower emission regions falls within a range from 90° to 150° both inclusive.

### BACKGROUND OF THE INVENTION

1. Field of the Invention

The present invention relates to a liquid crystal display device performing video display through division of an emission region in a light source device such as backlight.

2. Description of the Related Art

In recent years, a demand for thinner displays has been growing especially for liquid crystal televisions and PDPs (Plasma Display Panels). Displays for mobile use are often liquid crystal displays, and are especially expected to be high in reproducibility of color with good fidelity.

In a liquid crystal display device, liquid crystal elements are generally subjected to an operation of line-sequential driving, i.e., operation of line-sequential writing, in the vertical direction from an upper to lower end on the display screen. The liquid crystal elements are those respectively provided in a plurality of pixels arranged in a matrix. At the frame frequency of about 30 to 240 Hz, a frame is generally produced.

Also in the liquid crystal display device, the light source section, i.e., backlight, has been a fluorescent tube such as CCFL (Cold Cathode Fluorescent Lamp) or HCFL (Hot Cathode Fluorescent Lamp), or has been made of LED (Light Emitting Diode), for example. The backlight is mainly in two configurations of direct-light and edge-light types.

Such a liquid crystal display device is known to often cause moving images to appear blurred due to the slow response speed of the liquid crystal elements themselves, and the holding characteristics of the elements during driving. The blurring in moving images due to the latter is caused by holding of a voltage level corresponding to a video signal for the duration after writing of the video signal to the liquid crystal elements in a frame period before the timing for writing thereof in the next frame period. To be specific, such blurring in moving images is easily observed as afterimage in any video in which an object(s) move fast.

For solving such a blurring problem of moving images, for example, a previous technique has been proposed to divide an emission region for a direct-light backlight into a plurality of regions, and to subject the resulting divided regions one by one to a turn-ON operation in synchronization with driving of liquid crystal elements for writing thereto (for example, refer to Japanese Unexamined Patent Publication No. 2000-321993 and No. 2000-321551). Another technique has been also proposed specifically for an edge-light backlight, i.e., a light source is provided to a light guide plate on its upper and lower sides, and these light sources are alternately turned ON (for example, refer to Japanese Unexamined Patent Publication No. 2008-83427). These techniques are aiming to solve the blurring problem of moving images by providing an emission period and a no-emission period to the light source(s), thereby performing a so-called blinking operation in synchronization with driving of the liquid crystal elements for writing thereto.

### SUMMARY OF THE INVENTION

In such techniques of Japanese Unexamined Patent Publication No. 2000-321993 and No. 2000-321551, the blinking operation may solve the blurring problem of moving images, however, the resulting effects are not good enough specifically in the border region between any two of the divided emission regions because the light each coming therefrom is to be mixed in the border region. In consideration thereof, for solving the blurring problem of moving images over the entire display screen with the techniques as above, there needs to additionally provide a member for partition use to each of the divided emission regions. This thus increases the number of device components, thereby resulting in a cost increase.

Also with the technique in Japanese Unexamined Patent Publication No. 2008-83427 described above, the light each coming from the upper and lower light sources is mixed together around the center of the light guide plate, i.e., around the center on the display screen, and thus the blurring problem of moving images is not yet solved enough for the region around the center. Accordingly, for solving the blurring problem of moving images over the entire display screen also with this technique, there requires any design idea such as configuring the light guide plate with upper and lower portions, or applying special processing to the light guide plate. Such a design idea resultantly increases the structure complexity, and causes a need to use an expensive light guide plate, thereby also resulting in a cost increase.

As is known from the above, the liquid crystal display devices of the previous technologies all have a difficulty in realizing higher-quality images with a lower cost, and thus there has been a demand for a technology that can overcome the difficulty.

It is thus desirable to provide a liquid crystal display device that can realize higher-quality images with a lower cost.

A liquid crystal display device according to an embodiment of the invention is provided with a light source section, a liquid crystal display panel configured to include a plurality of pixels and to be in charge of video display by modulating, based on a video signal, a light coming from the light source section, and a drive section performing driving on the light source section for turning ON and OFF, as well as driving on the pixels in the liquid crystal display panel for line-sequential writing of the video signal. This drive section performs the driving on the light source section for turning ON and OFF in synchronization with the driving of the pixels for the light-sequential writing such that, the liquid crystal display panel is selectively illuminated with the light from a lower emission region of whole emission region in the light source section when the pixels in an upper display region of whole display region in the liquid crystal display panel are under the driving for line-sequential writing, and such that, the liquid crystal display panel is selectively illuminated with the light from an upper emission region of the whole emission region when the pixels in a lower display region of the whole display region are under the driving for line-sequential writing. A phase difference between an emission period in the upper emission region and an emission period in the lower emission region falls within a range from 90° to 150° both inclusive.

In such a liquid crystal display device according to the embodiment of the invention, as described above, the drive section the drive section performs the driving on the light source section for turning ON and OFF in synchronization with the driving of the pixels for the light-sequential writing such that, the liquid crystal display panel is selectively illuminated with the light from a lower emission region of whole emission region in the light source section when the pixels in an upper display region of whole display region in the liquid crystal display panel are under the driving for line-sequential writing, and such that, the liquid crystal display panel is selectively illuminated with the light from an upper emission region of the whole emission region when the pixels in a lower display region of the whole display region are under the driving for line-sequential writing. This accordingly reduces the degree of blurring in moving images resulted from the slow response speed of the liquid crystal elements because a light starts coming from the light source section after the lapse of a response period (transition period of light transmittance) of the liquid crystal elements in the pixels. Moreover, the upper and lower emission regions are each under the control of the emission period and the no-emission period, thereby favorably realizing the impulse-type video display. This accordingly reduces the degree of blurring in moving images resulted from afterimage resulted from the holding characteristics of the liquid crystal elements. In this case, since a phase difference between the emission period in the upper emission region and the emission period in the lower emission region falls within a range from 90° to 150° both inclusive, the blurring in moving images becomes less conspicuous uniformly over the entire display screen, i.e., throughout over the upper and lower end portions and the center portion.

With the liquid crystal display device according to an embodiment of the invention, the drive section performs the driving on the light source section for turning ON and OFF in synchronization with the driving of the pixels for the light-sequential writing such that, the liquid crystal display panel is selectively illuminated with the light from a lower emission region of whole emission region in the light source section when the pixels in an upper display region of whole display region in the liquid crystal display panel are under the driving for line-sequential writing, and such that, the liquid crystal display panel is selectively illuminated with the light from an upper emission region of the whole emission region when the pixels in a lower display region of the whole display region are under the driving for line-sequential writing. This accordingly reduces the degree of blurring in moving images resulted from the slow response speed of the liquid crystal elements, and from afterimage resulted from the holding characteristics of the liquid crystal elements. Moreover, since the phase difference between the emission period for the upper emission region and the emission period in the lower emission region is so set as to fall within a range from 90° to 150° both inclusive, the blurring in moving images becomes less conspicuous uniformly over the entire display screen. This accordingly enables to improve the characteristics of moving images on the entire display screen with no addition of structure complexity of the light source section, i.e., the original structure of the previous light source section is used as it is. As such, the image quality can be increased with a reduced cost.

### BRIEF DESCRIPTION OF THE DRAWINGS

FIG. 1 is a block diagram illustrating the entire configuration of a liquid crystal display device in an embodiment of the invention;

FIG. 2 is a circuit diagram illustrating an exemplary detailed configuration of a pixel of FIG. 1;

FIG. 3 is a diagram illustrating exemplary detailed configurations of a backlight drive section and a backlight of FIG. 1;

FIG. 4 is a schematic diagram for illustrating an emission region of the backlight;

FIG. 5 is a timing chart for illustrating lamp drive signals of FIG. 3;

FIG. 6 is a timing chart illustrating the operation of the liquid crystal display device in the embodiment;

FIGS. 7A and 7B are each a timing chart for illustrating a response waveform of a liquid crystal element;

FIGS. 8A and 8B are each a timing chart of the relationship between the response waveform of the liquid crystal element and an emission period for the backlight in the embodiment;

FIG. 9 is a characteristics diagram illustrating, together with a comparative example, an exemplary relationship between the vertical position on a display screen and the degree of blurring in moving images;

FIGS. 10A and 10B are each a characteristics diagram illustrating, together with a comparative example, an exemplary relationship between an emission-period phase difference in upper and lower emission regions and the degree of blurring in moving images in accordance with the vertical position on the display screen;

FIG. 11 is a characteristics diagram illustrating an exemplary relationship between an on-duty ratio in the upper and lower emission regions and the degree of blurring in moving images; and

FIGS. 12A and 12B are a schematic diagram illustrating the schematic configuration and a timing chart illustrating the turning ON/OFF operation, respectively, of a backlight in a modified example.

### DETAILED DESCRIPTION OF THE PREFERRED EMBODIMENT

In the below, an embodiment of the invention will be described in detail by referring to the accompanying drawings. The description is made in the following order:

1. Embodiment (exemplary liquid crystal display device using a backlight of a direct-light type)

2. Modified Example (exemplary liquid crystal display device using a backlight of an edge-light type)

### Embodiment

### (Entire Configuration of Liquid Crystal Display Device)

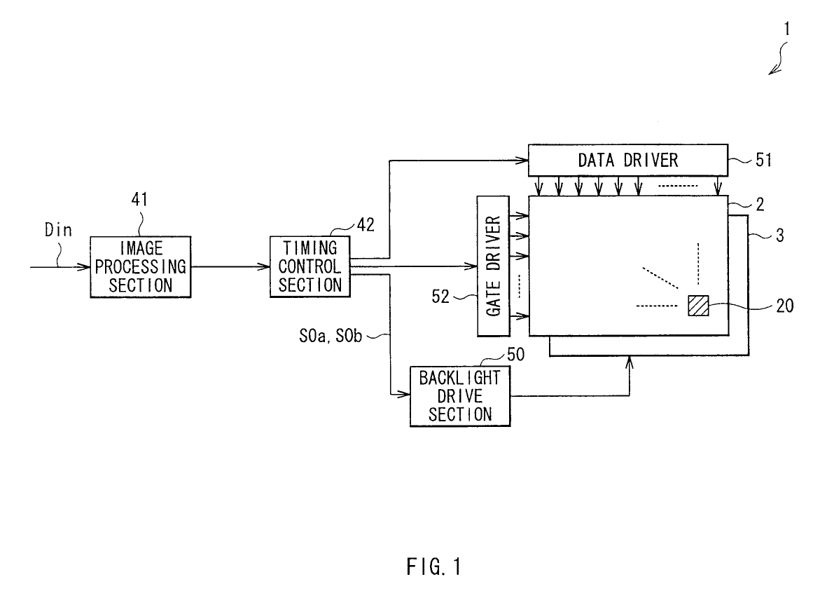

FIG. 1 is a block diagram showing the configuration of a liquid crystal display device, i.e., liquid crystal display device 1, in the embodiment of the invention. The liquid crystal display device 1 is of a so-called transmissive type, and is configured to include a backlight 3 (light source section), and a transmissive liquid crystal display panel 2. This liquid crystal display device 1 is also provided with an image processing section 41, a timing control section 42, a backlight drive section 50, a data driver 51, and a gate driver 52. Among these device components, the timing control section 42, the backlight drive section 50, the data driver 51, and the gate driver 52 are all a specific example of a “drive section” in the embodiment of the invention.

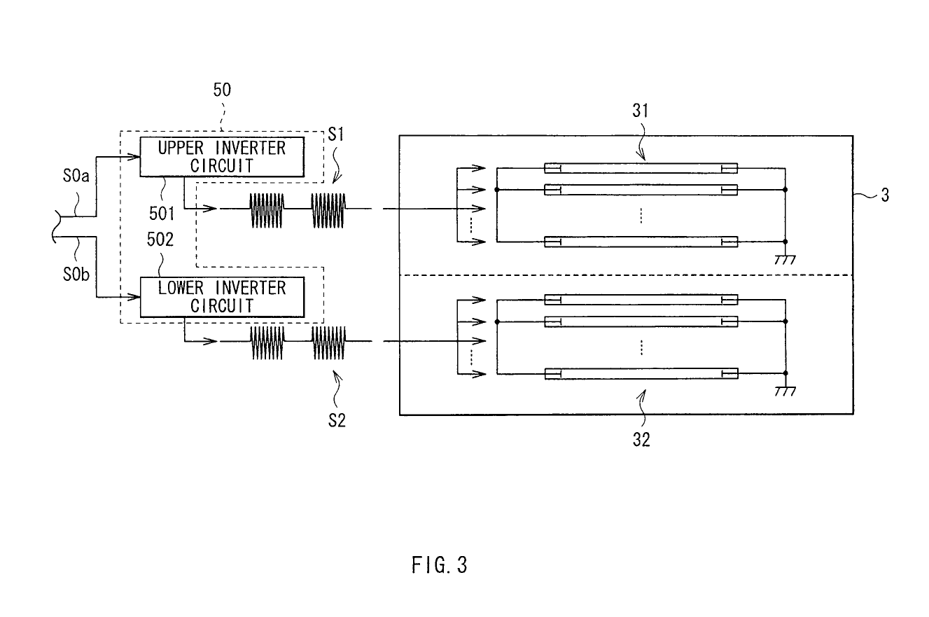

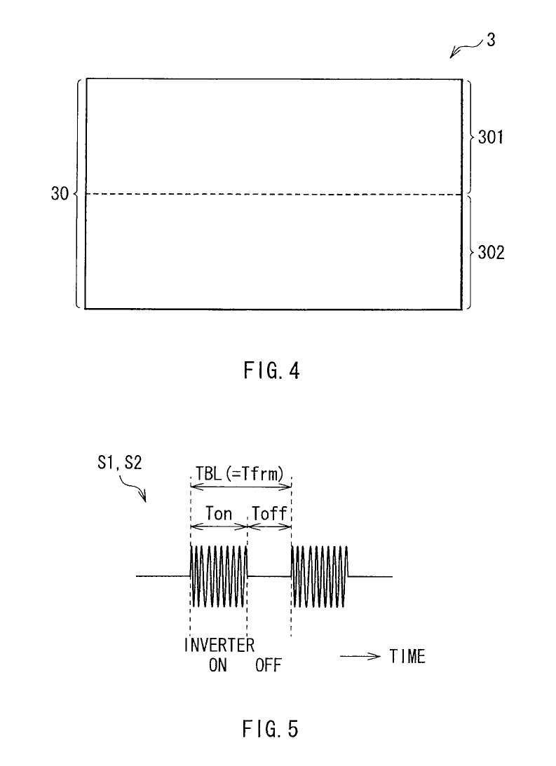

The backlight 3 is a light source from which a light is directed toward the liquid crystal display panel 2. In this example, the backlight 3 is of a direct-light type using a plurality of fluorescent tubes. The detailed configuration of the backlight 3 will be described later (FIGS. 3 and 4).

The liquid crystal display panel 2 performs video display based on an input video signal Din by modulating a light coming from the backlight 3 based on a video voltage provided by the data driver 51 (described later), according to a drive signal supplied from the gate driver 52 (described later). The liquid crystal display panel 2 includes a plurality of pixels 20 arranged in a matrix as a whole.

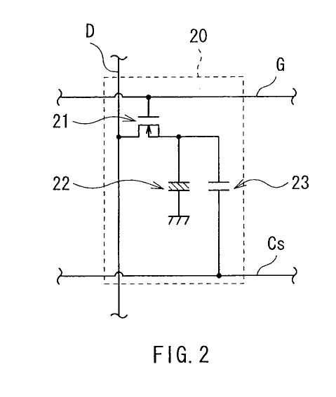

FIG. 2 shows an exemplary circuit configuration of a pixel circuit in each of the pixels 20. The pixels 20 are each configured to include a liquid crystal element 22, a TFT (Thin Film Transistor) element 21, and an auxiliary capacity element 23. Such pixels 20 are each connected with a gate line G, a data line D, and an auxiliary capacity line Cs. The gate line G is for line-sequentially selecting any pixel to be driven, and the data lien D is for supplying a video voltage to the pixels to be driven. The video voltage here is the one provided by the data driver 51.

The liquid crystal element 22 performs the display operation in accordance with the video voltage provided at one end thereof from the corresponding data line D through the TFT element 21. This liquid crystal element 22 is configured by sandwiching a liquid crystal layer (not illustrated) between a pair of electrodes (not illustrated). This liquid crystal layer is made of for example, a VA (Vertical Alignment)-mode or TN (Twisted Nematic)-mode liquid crystal. One (end) of the pair of electrodes in the liquid crystal element 22 is connected to a drain of the TFT element 21, and to one end of the auxiliary capacity element 23. The other (end) of the electrodes is grounded. The auxiliary capacity element 23 is for stabilizing the accumulated charge of the liquid crystal element 22. One end of this auxiliary capacity element 23 is connected to one end of the liquid crystal element 22, and to the drain of the TFT element 21. The remaining end of the auxiliary capacity element 23 is connected to the corresponding auxiliary capacity line Cs. The TFT element 21 is a switching element for supplying the video voltage to one end of the liquid crystal element 22, and to one end of the auxiliary capacity element 23. This video voltage is the one based on a video signal D1, and the TFT element 21 is configured by a MOS-FET (Metal Oxide Semiconductor—Field Effect Transistor). A gate of this TFT element 21 is connected to the corresponding gate line G, and a source thereof is connected to the corresponding data line D. The drain of the TFT element 21 is connected to one end of the liquid crystal element 22, and to one end of the auxiliary capacity element 23.

The image processing section 41 performs predetermined image processing on an input video signal Din coming from the outside. Such predetermined image processing includes processing for contrast enhancement, sharpness enhancement, overdriving, and others. The image processing section 41 then outputs the resulting video signal after image processing to the timing control section 42.

The timing control section 42 controls driving timing in the backlight drive section 50, the gate driver 52, and the data driver 51, and supplies the video signal after the image processing input from the image processing section 41 to the data driver 51. To be specific, the timing control section 42 controls the backlight 3 in the backlight drive section 50 to be turned on, and also controls driving for writing of a video signal to each of the pixels 20 in the liquid crystal display panel 20. Although details will be given later, the turn-ON driving in the backlight drive section 50 is controlled using control signals S0a and S0b.

In response to the timing control performed by the timing control section 42, the gate driver 52 line-sequentially drives, i.e., performs line-sequential driving for writing to, the pixels 20 in the liquid crystal display panel 2 along the gate lines G described above.

The data driver 51 supplies, to each of the pixels 20 in the liquid crystal display panel 2, a video voltage based on the video signal provided by the timing control section 42. To be specific, the data driver 51 applies D/A (Digital/Analog) conversion to the video signal, and forwards the resulting analog video signal, i.e., the video voltage described above, to each of the pixels 20.

The backlight drive section 50 controls turn-ON operation (light-emission operation) of the backlight 3 in accordance with the timing control by the timing control section 42. In other words, the backlight drive section 50 performs turn-ON operation on the backlight 3 in accordance with the control signals S0a and S0b coming from the timing control section 42. Note that the detailed configuration of the backlight control section 50 will be described later (FIGS. 3 and 5).

### (Detailed Configurations of Backlight Drive Section 50 and Backlight 3)

FIG. 3 is a block diagram illustrating an exemplary detailed configuration of the backlight drive section 50, and that of the backlight 3.

### (Backlight 3)

The backlight 3 is of a direct type including a light source section. The light source section is configured to include a plurality of fluorescent tubes 31 and 32 disposed in line, which are exemplified by CCFL or HCFL. These fluorescent tubes 31 and 32 are each configured to include a discharge tube and an electrode that are not illustrated. The discharge tube is made of glass, for example, and is filled therein with a phosphor layer (not illustrated) and discharge gas such as neon (Ne), argon (Ar), or mercury (Hg). Such a configuration allows discharging from the electrodes through the discharge tubes.

In this example, the fluorescent tube 31 (upper light source) is disposed on the side above the emission region of the backlight 3, i.e., a whole emission region 30 that will be described later. On the other hand, the fluorescent tube 32 (lower light source) is disposed on the side below this emission region. These fluorescent tubes 31 and 32 are connected to each other in parallel.

As such, as illustrated in FIG. 4, the whole emission region 30 of the backlight 3 is divided into, i.e., separated into, two emission regions of an upper emission region 301 including the fluorescent tube 31, and a lower emission region 302 including the fluorescent tube 32. In other words, this whole emission region 30 is divided into the upper and lower emission regions 301 and 302 along the up-and-down direction, i.e., vertical direction on the display screen. This configuration accordingly enables the operation of dividing emission (dividing turn-ON/OFF) on the divided region basis as will be described later. Note here that this backlight 3 is not provided with any member serving as a partition between these upper and lower emission regions 301 and 302 so that the region is not physically divided.

### (Backlight Drive Section 50)

As illustrated in FIG. 3, the backlight drive section 50 includes two inverter circuits of an upper inverter circuit 501, and a lower inverter circuit 502. The upper inverter circuit 501 performs driving on the fluorescent tubes 31 in the upper emission region 301 for turning ON and OFF using a lamp drive signal S1, in accordance with the control signal S0a coming from the timing control section 42. On the other hand, the lower inverter circuit 502 performs driving on the fluorescent tubes 32 in the lower emission region 302 for turning ON and OFF using a lamp drive signal S2, in accordance with the control signal S0b coming from the timing control section 42. In other words, these upper and lower inverter circuits 501 and 502 generate the lamp drive signals S1 and S2 based on the control signals S0a and S0b, respectively, the control signals S0a and S0b having the frame frequency.

The voltage waveform (timing waveform) of these lamp drive signals S1 and S2 looks like as illustrated in FIG. 5, for example. To be specific, the lamp drive signals S1 and S2 each have the cycle, i.e., dimming cycle TBL, (substantially) the same as a frame period Tfrm during the line-sequential driving for writing in the liquid crystal display panel 2 that will be described later. In other words, the lamp drive signals S1 and S2 each have the frequency, i.e., dimming frequency, (substantially) the same as the frame frequency during the above-described line-sequential driving for writing, i.e., about 30 to 240 Hz. In other words, the upper and lower inverter circuits 501 and 502 are configured so as to perform the turn-ON driving based on the control signals S0a and S0b, respectively, in synchronization with the above-described line-sequential driving for writing.

The dimming cycle TBL is configured by an ON period (emission period) Ton, and an OFF period (no-emission period) Toff. In the ON period, the inverter circuits are turned ON for operation, i.e., the fluorescent tubes 31 and 32 are put in the turn-ON state, and in the OFF period, the inverter circuits are turned OFF for operation, i.e., the fluorescent tubes 31 and 32 are put in the turn-OFF state. Although the details will be given later, settings are made so as to provide a predetermined phase difference (phase difference φ that will be described later) between the ON period Ton for the lamp drive signal S1, i.e., the emission period for the upper emission region 301, and the ON period for the lamp drive signal S2, i.e., the emission period for the lower emission region 302.

### (Effects and Advantages of Liquid Crystal Display Device)

Described next are the effects and advantages of the liquid crystal display device 1 in this embodiment.

### (1. Outlines of Display Operation)

With this liquid crystal display device 1, as illustrated in FIG. 1, first of all, the image processing section 41 performs the above-described predetermined image processing on an input video signal Din, thereby generating a video signal as a result of the image processing. This resulting video signal after the image processing is supplied to the data driver 51 through the timing control section 42. The data driver 51 then applies D/A conversion to the resulting video signal after the image processing so that a video voltage being an analog signal is generated. The gate driver 52 and the data driver 51 each output a drive voltage to each of the pixels 20 so that the operation for display driving is accordingly performed.

To be specific, as illustrated in FIG. 2, the TFT elements 21 are turned ON and OFF in accordance with a selection signal provided by the gate driver 52 over the gate lines G. This accordingly allows conduction of electricity selectively between the data lines D and the liquid crystal elements 22, and between the data lines D and the auxiliary capacity elements 23. As a result, the video voltage coming from the data driver 51 is directed to the liquid crystal elements 22, thereby leading to the operation for line-sequential display driving, i.e., drive operation for line-sequential writing.

On the other hand, in the backlight drive section 50, as illustrated in FIG. 3, the upper and lower inverter circuits 501 and 502 performs turn-ON driving in synchronization with the drive operation for line-sequential writing described above based on the control signals S0a and S0b respectively provided by the timing control section 42. To be specific, as illustrated in FIGS. 3 to 5, the upper inverter circuit 501 generates the lamp drive signal S1 based on the control signal S0a, and using this lamp drive signal S1, performs driving on the fluorescent tubes 31 in the upper emission region 301 for turning ON and OFF. On the other hand, the lower inverter circuit 502 generates the lamp drive signal S2 based on the control signal S0b, and using this lamp drive signal S2, performs driving on the fluorescent tubes 32 in the lower emission region 302 for turning ON and OFF. With such an operation, the fluorescent tubes 31 and 32 are each operated to turn ON and OFF as will be described later in detail so that the illumination light is emitted from the backlight 3.

In each of the pixels 20 provided with the video voltage, the illumination light from the backlight 3 is modulated in the liquid crystal display panel 2, and the resulting light is emitted as display light. As such, the liquid crystal display device 1 performs video display based on the input video signal Din.

### (2. Details of Display Operation)

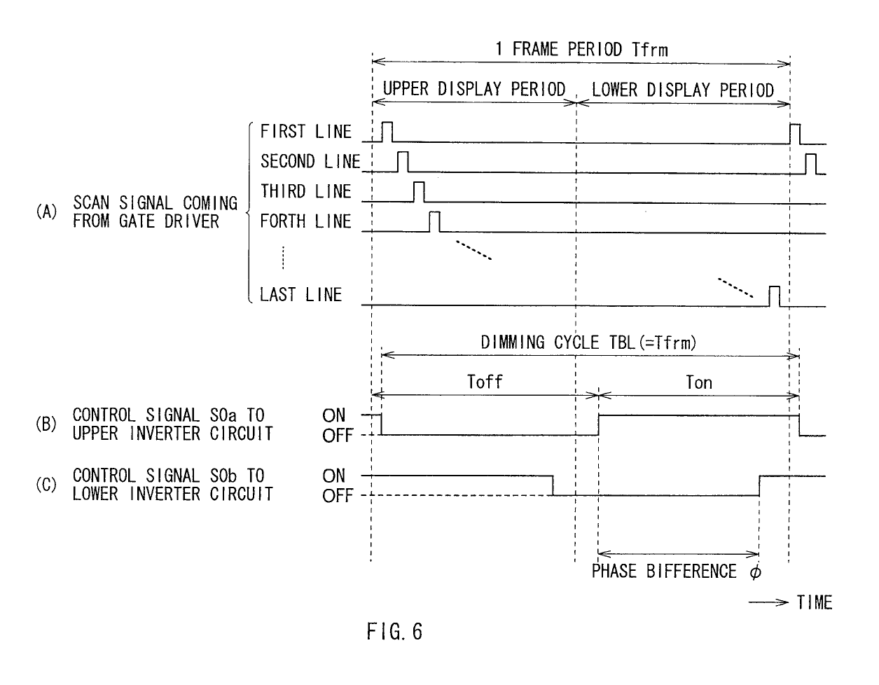

By referring to FIGS. 6 to 11, described in detail next is the emission operation, i.e., blinking operation, to be performed by the respective divided emission regions, i.e., the upper and lower emission regions 301 and 302, which are one characteristic of the invention.

### (2-1. General Outlines of Blinking Operation)

FIG. 6 is a timing chart for illustrating the general outlines of the blinking operation in the liquid crystal display device 1. In FIG. 6, Part (A) indicates scan signals output from the gate driver 52 to each of the gate lines G (from the first line to the last line). Also in FIG. 6, Part (B) indicates the control signal S0a to be provided to the upper inverter circuit 501, and Part (C) indicates the control signal S0b to be provided to the lower inverter circuit 502.

First of all, as illustrated in Part (A) of FIG. 6, the pixels 20 in the liquid crystal display panel 2 are each driven for line-sequential writing generally from the first (horizontal) line to the last (horizontal) line (along the vertical direction), i.e., from the upper end of the display screen toward the lower end thereof. At this time, the frame frequency corresponding to a period of producing one frame, i.e., one frame period Tfrm, is of about 30 to 240 Hz as described above, for example.

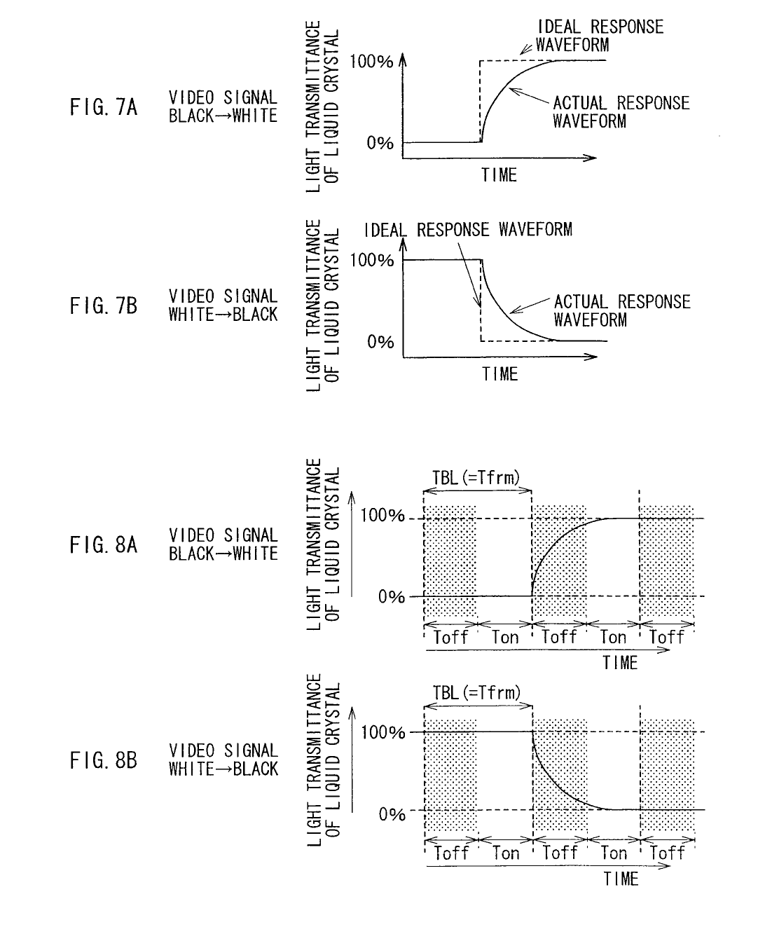

The concern here is that, as illustrated in FIGS. 7A and 7B, the liquid crystal elements 22 in the pixels 20 each show a change in its response waveform slower in reality than ideal when the video signal shows a change in voltage level. In other words, when the video signal shows a voltage change between the state of black display and the state of white display, i.e., a voltage change between the minimum gray-scale voltage and the maximum gray-scale voltage, for example, the liquid crystal elements 22 each show a slower response in reality than ideal. Due to such a slower response speed of the liquid crystal elements 22 themselves, the moving images are often caused to appear blurred easily during display thereof.

In consideration thereof, in this embodiment, as exemplarily illustrated in Part (A) to Part (C) of FIG. 6, the upper and lower emission regions 301 and 302 are separately subjected to the emission operation, i.e., blinking operation. In other words, the backlight drive section 50, i.e., the upper and lower inverter circuits 501 and 502, performs the turn-ON driving based on the control signals S0a and S0b provided from the timing control section 42 in synchronization with the above-described line-sequential driving for writing in the liquid crystal display panel 2.

More specifically, first of all, when the pixels 20 in the upper display region of the whole display region (corresponding to the upper display period in FIG. 6) in the liquid crystal display panel 2 are being driven for line-sequential writing, the backlight drive section 50 starts operating for turning ON to allow light emission selectively from the lower emission region 302 in the whole emission region 30. In other words, at this time, the control signal S0a corresponding to the upper emission region 301 is in the OFF period Toff, and the control signal S0b corresponding to the lower emission region 302 is in the ON period Ton.

When the pixels 20 in the lower display region of the whole display region (corresponding to the lower display period in FIG. 6) in the liquid crystal display panel 2 are being driven for line-sequential writing, the backlight drive section 50 starts operating for turning ON to allow light emission selectively from the upper emission region 301 in the whole emission region 30. In other words, at this time, the control signal S0a corresponding to the upper emission region 301 is in the ON period Ton, and the control signal S0b corresponding to the lower emission region 302 is in the OFF period Toff.

Note that, at this time, as illustrated in FIG. 6, settings are made so as to provide the above-described predetermined phase difference φ between the ON period Ton in the control signal S0a, i.e., the emission period for the upper emission region 301, and the ON period in the control signal S0b, i.e., the emission period for the lower emission region 302.

Therefore, as exemplarily illustrated in FIGS. 8A and 8B, when the video signal shows a voltage change between the state of black display and the state of white display, for example, a light starts coming from the backlight 3 after the lapse of the response period (transition period of light transmittance) of the liquid crystal elements 22 in the pixels 20. In other words, in the response period of the liquid crystal elements 22, the upper or lower emission region 301 or 302 is set to the OFF period Toff depending on the positions of the pixels 20 including the liquid crystal elements 22 on the display screen. After the lapse of such a response period, the upper or lower emission region 301 or 302 is set to the ON period Ton. This accordingly reduces the degree of blurring in moving images resulted from the slower response speed of the liquid crystal element 22.

In this manner, for each of the upper display region and the lower emission region in the liquid crystal display panel 2, the emission period for the light from the backlight 3, i.e., the ON period Ton, and the no-emission period therefor, i.e., the OFF period Toff are allocated, and therefore the impulse-type video display is realized. This accordingly reduces the degree of blurring in moving images due to the afterimage resulted from the holding characteristics of the liquid crystal elements 22.

### (2-2. About Phase Difference and Range for On-Duty Ratio in Emission Regions)

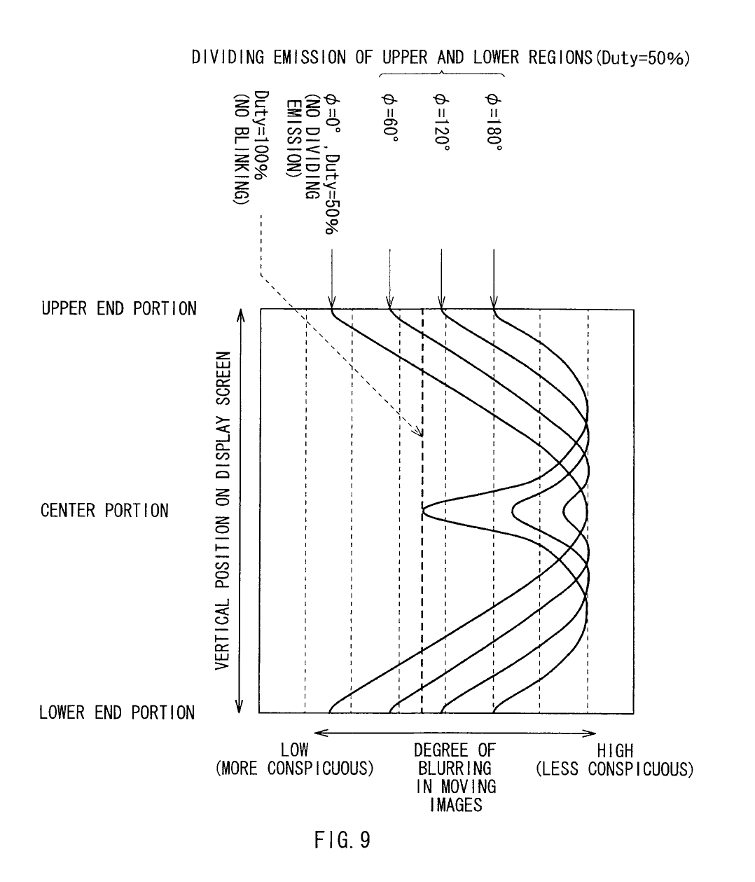

FIG. 9 shows, together with a comparative example, an exemplary relationship between the vertical (V-direction) position on the display screen of the liquid crystal display panel 2, and the degree of blurring in moving images, i.e., resolution of moving images. In FIG. 9, data denoted as “Vertically-Dividing Emission (On-Duty Ratio Duty (Ratio of On Period Ton in Dimming Cycle TBL (Ton/TBL))=50%” corresponds to the example in this embodiment, and such data shows three examples with the phase difference if of 60°, 120°, and 180°. The data with the “phase difference φ=0°” corresponds to the data when no dividing emission is performed (comparative example 2), and the data with the “Duty=100%” corresponds to the data when no blinking operation is performed, i.e., when the backlight is always ON (comparative example 1).

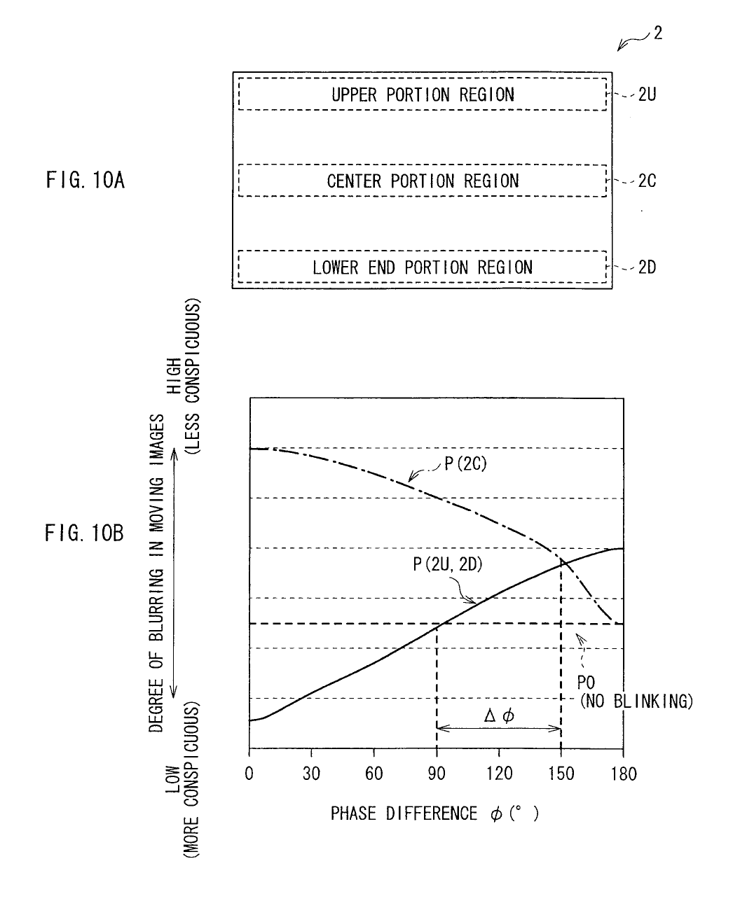

FIG. 10B shows, together with a comparative example, an exemplary relationship between the above-described phase difference φ and the degree of blurring in moving images. The relationship is based on the vertical position on the display screen in the liquid crystal display panel 2 of FIG. 10A, i.e., an upper end portion region 2U, a center portion region 2C, and a lower end portion region 2D. Note here that the degree of blurring in moving images in FIGS. 9 to 10B are those derived based on the assessment result of the subjective assessment conducted by a plurality of observers.

First of all, as is known from FIG. 9, in the comparative example 2 in which no dividing emission is performed, compared with the comparative example 1 in which no blinking operation is performed, the blurring in moving images is less conspicuous in the center portion on the display screen but is more conspicuous in the upper and lower end portions thereon. This is because, in the center portion on the display screen, the backlight 3 is turned OFF at the timing when the liquid crystal elements 22 are being driven for line-sequential writing. On the other hand, in the upper and lower end portions on the display screen, the backlight 3 emits lights at the timing when the liquid crystal elements 22 are being driven for line-sequential writing. In other words, this comparative example 2 obviously has a difficulty in making the blurring in moving images less conspicuous uniformly over the entire display screen, i.e., throughout over the upper and lower end portions and the center portion. On the other hand, when the phase difference φ=180° in the example, conversely, the blurring in moving images is less conspicuous in the upper and lower end portions on the display screen compared with the comparative example 1, but in the center portion on the display screen, no improvement is observed because the degree of blurring therein is the same as in the comparative example 1. This is because, in the center portion on the display screen being the border portion and therearound between the upper and lower emission regions 301 and 302, the lights from these two emission regions are mixed together, thereby reducing the effects that are supposed to be achieved by the blinking operation in terms of degree of blurring. Herein, with a value decrease of the phase difference φ from 180° to 120°, 60°, and then to 0°, the blurring in moving images becomes less conspicuous in the center portion on the display screen, but becomes more conspicuous by degrees in the upper and lower end portions thereon.

More in detail, as illustrated in FIG. 10B, with a value increase of the phase difference φ from 0° to 180°, in the center portion region 2C on the display screen, the blurring in moving images becomes more conspicuous by degrees (refer to a reference numeral P(2C) in the drawing). Especially with the phase difference φ=150° or larger, the blurring in moving images abruptly becomes more conspicuous, and with the phase difference φ=180°, the degree of blurring reaches the same level as in the comparative example 1 described above (refer to a reference numeral P0 in FIG. 10B). This tells that, in the center portion region 2C on the display screen, the blurring in moving images can become effectively less conspicuous especially when the phase difference φ=150° or smaller.

On the other hand, with a value increase of the phase difference φ from 0° to 180°, the blurring in moving images becomes less conspicuous by degrees in both the upper and lower end portion regions 2U and 2D on the display screen (refer to a reference numeral P(2U, 2D) in FIG. 10B). Specifically, when the phase difference φ=90°, the degree of blurring looks the same as in the comparative example 1 (refer to a reference numeral P0 in FIG. 10B). This tells that, in both the upper and lower end portion regions 2U and 2D on the display screen, the blurring in moving images can become less conspicuous compared with the previous technology (comparative example 1) when the phase difference φ=90° or larger.

In consideration thereof, in this embodiment, settings are made so that such a phase difference φfalls within a range from 90° to 150° both inclusive)(90°≦φ≦150°. This phase difference is the one between the ON period Ton (emission period) for the upper emission region 301, and the ON period Ton (emission period) for the lower emission region 302. Such settings are for firstly solving the blurring problem of moving images in the center portion region 2C being the most important portion during video display (φ≦150°), and also for not making more conspicuous the blurring in moving images in the upper and lower end portion regions 2U and 2D being the less important portion during video display (90°≦φ)) compared with the comparative example 1 with no blinking operation. In this embodiment, with such settings of the phase difference φto fall within the range from 90° to 150° both inclusive, i.e., the phase difference φfalls within a phase difference range Δ of FIG. 10B, the blurring in moving images becomes less conspicuous uniformly over the entire display screen, i.e., throughout over the upper and lower end portions and the center portion.

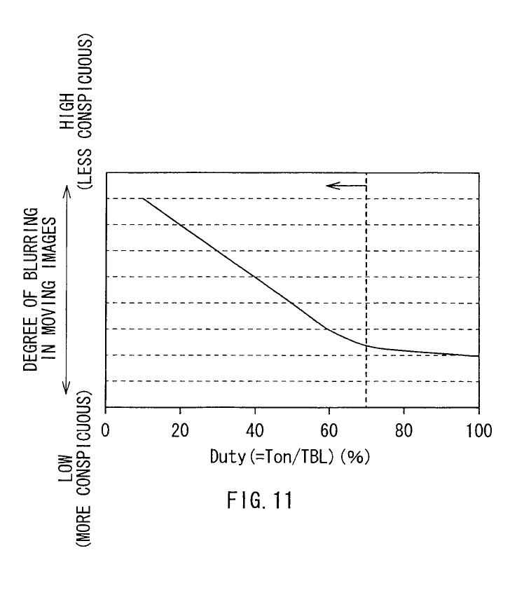

FIG. 11 shows an exemplary relationship between the on-duty ratio Duty described above and the degree of blurring in moving images. Note here that the blurring degrees in moving images in FIG. 11 are also those derived based on the assessment result of the subjective assessment conducted by a plurality of observers.

As is known from FIG. 11, the blurring in moving images becomes less conspicuous by degrees with a value decrease of the on-duty ratio Duty from 100% to 0%. Especially when the on-duty ratio Duty=70% or lower, the blurring in moving images becomes abruptly less conspicuous. In consideration thereof, in this embodiment, the on-duty ratio Duty (ratio of the ON period in the dimming cycle TBL (Ton/TBL)) is preferably set to be larger than 0% but equal to or lower than 70% for each of the upper and lower emission regions 301 and 302 in the backlight 3.

As such, in this embodiment, when the pixels 20 in the upper display region of the whole display region in the liquid crystal display panel 2 are being driven for line-sequential writing, the backlight drive section 50 starts operating for turning ON to allow light emission selectively from the lower emission region 302 in the whole emission region 30. When the pixels 20 in the lower display region of the whole display region in the liquid crystal display panel 2 are being driven for line-sequential writing, the backlight drive section 50 starts operating for turning ON to allow light emission selectively from the upper emission region 301 in the whole emission region 30. This favorably reduces the degree of blurring in moving images due to the slow response speed of the liquid crystal elements 22 and the afterimage resulted from the holding characteristics of the liquid crystal elements 22. Also in the backlight 3, the settings are made so that the phase difference φ between the ON period Ton for the upper emission region 301 and the ON period Ton for the lower emission region 302 falls within the range from 90° to 150° both inclusive, thereby being able to make the blurring in moving images less conspicuous uniformly over the entire display screen. This accordingly enables to improve the characteristics of moving images on the entire display screen with no addition of structure complexity of the backlight 3, e.g., no need for a member for partition use between the upper and lower emission regions 301 and 302, and the original structure of the previous backlight may be used as it is. As such, the image quality can be made higher with a reduced cost.

Note that exemplified in the embodiment is the backlight of a direct-light type using the fluorescent tubes, i.e., the fluorescent tubes 31 and 32. The light source is surely not restricted in type thereto, and a backlight of a direct-light type using LEDs surely leads to the same effects as achieved in the embodiment.

### Modified Example

Described next is a modified example of the embodiment described above. Herein, any device component same as that in the above embodiment is provided with the same reference numeral, and is not described again if appropriate.

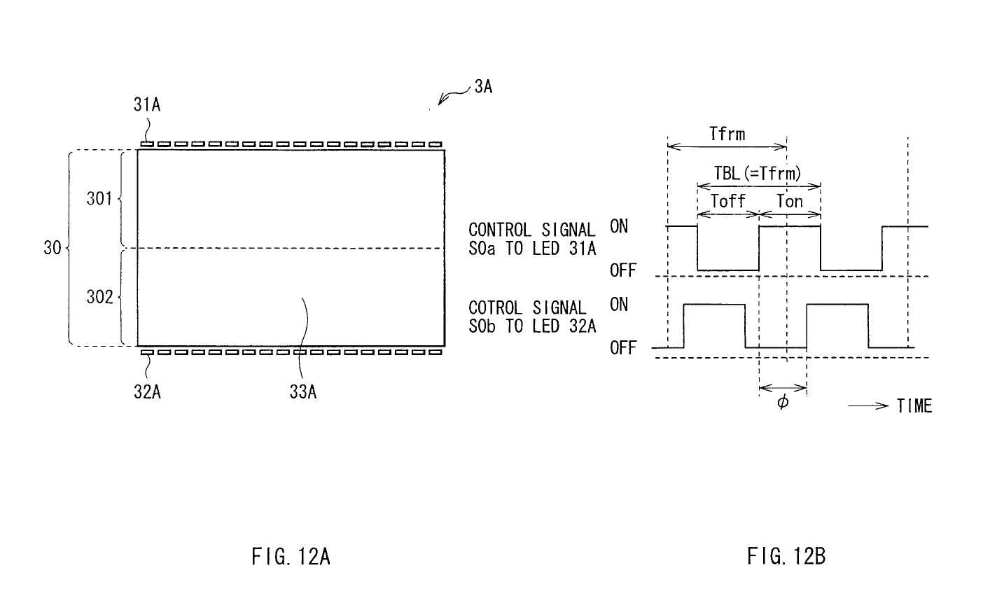

FIG. 12A is a schematic diagram showing the configuration of a backlight, i.e., backlight 3A, in the modified example, and FIG. 12B is a timing chart of the turn-ON operation (control operation) of this backlight 3A.

As illustrated in FIG. 12A, the backlight 3A of this modified example is configured to include a light guide plate 33A, and LEDs 31A and 31B different in type. The light guide plate 33A forms the whole emission region 30. To be specific, the LED 31A (upper light source) is disposed along the edge of the light guide plate 33A on the side of the upper emission region 301, and the LED 32A (lower light source) is disposed along the edge of the light guide plate 33A on the side of the lower emission region 302. In other words, this backlight 3A is of an edge-light type having the light sources on the upper and lower sides. Note that this light guide plate 33A is in a single structure, i.e., not divided into upper and lower portions, and is not processed specially. Therefore, the light guide plate 33A is in the configuration similar to that of the previous plate.

As illustrated in FIG. 12B, also in this modified example, the timing control section 42 and the backlight drive section 50 perform the blinking operation similarly to the above embodiment using the control signals S0a and S0b to the LEDs 31A and 32A, respectively.

Also in the modified example configured as such, the effects similar to the above embodiment can be achieved with the advantages similar thereto. In other words, the characteristics of moving images can be improved on the entire display screen with no addition of structure complexity of the backlight 3A, e.g., with the original structure of the previous backlight as it is, thereby being able to improve the image quality with a reduced cost.

Note that exemplified in this modified example is the backlight 3A of an edge-light type having the LEDs (the LEDs 31A and 31B) on the upper and lower sides, but the light source is surely not restricted in type thereto. In other words, a backlight of an edge-light type having the two fluorescence tubes on the upper and lower sides can also lead to the effects similar to those of the modified example.

### Other Modified Example

The present invention is described by referring to the embodiment and the modified example, but is surely not restricted thereto, and various other modifications and variations can be devised.

As an example, the control operation of the backlight drive section 50 described in the above embodiment and others performed by the timing control section 42 may be alternatively performed by hardware (circuit) or by software (program).

The present application contains subject matter related to that disclosed in Japanese Priority Patent Application JP 2010-005083 filed in the Japan Patent Office on Jan. 13, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display device, comprising:
a light source section;
a liquid crystal display panel configured to include a plurality of pixels and to be in charge of video display by modulating, based on a video signal, a light coming from the light source section; and
a drive section performing driving on the light source section for turning ON and OFF, as well as driving on the pixels in the liquid crystal display panel for line-sequential writing of the video signal,
wherein
the drive section performs the driving on the light source section for turning ON and OFF in synchronization with the driving of the pixels for the light-sequential writing such that,
the liquid crystal display panel is selectively illuminated with the light from a lower emission region of whole emission region in the light source section when the pixels in an upper display region of whole display region in the liquid crystal display panel are under the driving for line-sequential writing, and such that,
the liquid crystal display panel is selectively illuminated with the light from an upper emission region of the whole emission region when the pixels in a lower display region of the whole display region are under the driving for line-sequential writing, and
a phase difference between an emission period in the upper emission region and an emission period in the lower emission region falls within a range from 90° to 150° both inclusive.

2. The liquid crystal display device according to claim 1, wherein
in the upper and lower portions of the emission region, a duty ratio of the emission period to a unit drive cycle falls within a range from 0% to 70% upper inclusive.

3. The liquid crystal display device according to claim 1, wherein the light source section is of an edge-light type, including:
a light guide plate configuring the whole emission region;
an upper light source disposed along an edge of the light guide plate on a side of the upper emission region; and
a lower light source disposed along an edge of the light guide plate on a side of the lower emission region.

4. The liquid crystal display device according to claim 1, wherein the light source section is of a direct-light type, including:
an upper light source disposed within the upper emission region; and
a lower light source disposed within the lower emission region.

5. The liquid crystal display device according to claim 1, wherein the light source section is configured with a fluorescent tube or a light-emitting diode (LED).
